(19) United States
(12) Patent Application Publication
(10) Pub. No.: US 2015/0276463 A1
(43) Pub. Date: Oct. 1, 2015

(54) Non-Invasive Acoustic Monitoring of Subsea Containers

(71) Applicant: Schlumberger Technology Corporation, Sugar Land, TX (US)

(72) Inventors: Jason Stuart Milne, Elancourt (FR); Patrice Ligneul, Elancourt (FR); Erik Rhein-Knudsen, Clamart (FR); Vincent Alliot, Paris (FR); Olivier Sindt, Sugar Land, TX (US); Fadhel Rezgui, Clamart (FR)

(73) Assignee: Schlumberger Technology Corporation, Sugar Land, TX (US)

(21) Appl. No.: 14/417,118

(22) PCT Filed: Jul. 25, 2013
(86) PCT No.: PCT/IB2013/056115

§ 371 Date: Jan. 23, 2015

Related U.S. Application Data
(60) Provisional application No. 61/761,114, filed on Feb. 5, 2013.
(60) Provisional application No. 61/675,459, filed on Jul. 25, 2012.

(30) Foreign Application Priority Data
Jul. 25, 2012 (EP) 12290253.9

(51) Int. Cl. G01F 23/296; G01F 25/00; G01F 23/00

(52) U.S. Cl. CPC G01F 23/2961; G01F 23/0015; G01F 25/0061

(57) ABSTRACT

Systems and methods are described for non-invasively acoustically monitoring containers to distinguish gas contents from liquid contents. In some embodiments the container is part of a buoyancy tank (132) in a subsea pipeline network (102) used to transport production fluid from a subsurface wellhead (112) to surface facilities, and the systems and methods are used to detect water ingression into the buoyancy tank (132) and to transmit alert signals to the surface relating thereto.

### CROSS REFERENCE TO RELATED APPLICATIONS

This patent application claims the benefit of: U.S. Prov. Ser. No. 61/675,459 filed on Jul. 25, 2012; and U.S. Prov. Ser. No. 61/761,114 filed on Feb. 5, 2013, each of which is incorporated by reference herein.

### FIELD

This disclosure relates to methods and systems for non-invasively acoustically monitoring containers to distinguish gas contents from liquid contents. More specifically, this disclosure relates to monitoring the integrity of a subsea pipeline network to transport production fluid from a subsurface wellhead to surface facilities by non-invasively acoustically monitoring buoyancy tanks for water intrusion.

### BACKGROUND

Subsea oil and gas field architecture integrates a pipeline network to transport the production fluid from the wellhead to the surface facilities. As part of this pipeline network a riser pipe structure is provided close to the surface process facilities to lift the fluid from the seabed to the surface. See, e.g. U.S. Pat. No. 8,136,599.

In some applications, the riser structure may contain a buoyancy tank providing an uplift tension to one or more of the conduit(s) and flexible pipe connecting the top of the riser to surface process facilities.

Accidental flooding of the buoyancy tank could create a potential hazard to the riser structure and expose the field to a risk of catastrophic failure if a sufficient uplift tension is not applied to the vertical riser pipe system. The tensioning ensures that a marine structure doesn't experience excursions from its nominal upright position that would fall outside the acceptable limits, even during extreme weather conditions.

In order to mitigate the risk of failure, instrumentation may be installed to monitor possible accidental flooding of the buoyancy means. Tension can be monitored to ensure stability, taking into account the weight of the structure and the weight of the pipelines/risers hanging off the structure.

Known tension measurement techniques may have some inherent drift. A sudden ingression of a larger amount of water can be adequately detected as a transient change in the tension measurement above the time drift slope. However, inherent drift limits the ability of conventional measurement techniques to distinguish slow-rate of water ingression from tension measurement drift.

Thus, there is a need for a method and system to allow detection of low rates of water ingression that might not be recognized by conventional tension measurement means.

### SUMMARY

According to some embodiments, techniques are described for monitoring performance of buoyancy means that are used in a marine riser tower for the transport of hydrocarbon fluids (gas and/or oil) from offshore wells.

According to some embodiments a method is described for non-invasively acoustically monitoring contents of a container having a solid wall with an exterior wall surface and an interior wall surface. The method includes: transmitting an acoustic excitation signal from a first acoustic transducer mounted on the exterior wall surface, the acoustic excitation signal traveling through the solid wall towards the interior volume of the container; receiving an acoustic response signal at a location on the exterior wall surface, the acoustic response signal having traveled through the solid wall and being responsive to the excitation signal; processing data representing the received acoustic response signal; and distinguishing gas from liquid contents within the interior volume of the container based on the processing of the data representing the received acoustic response signal.

According to some embodiments the acoustic response is received using a second acoustic transducer and according to some other embodiments it is received by the first acoustic transducer. According to some embodiments, the amount of acoustic energy that is reflected at the interior wall surface when in contact with liquid is distinguished from amount of acoustic energy that is reflected at the interior wall surface when in contact with gas. According to some embodiments, an evaluation is made of the acoustic energy that has passed through a portion of the internal volume of the container and has been reflected off one or more internal structures of the container.

According to some embodiments the container forms part of a buoyancy tank configured to provide an upward buoyancy force thereby exerting an uplift tension on components of a subsea riser system for lifting a production fluid from a subsurface wellhead to a surface facility, and water ingress into the buoyancy tank is detected. According to some embodiments, an alert signal is automatically transmitted to a surface facility when a predetermined threshold value relating to water ingress into the buoyancy tank is met.

According to some embodiments, a system is described that is configured to non-invasively acoustically monitor contents of a container having a solid wall with an exterior wall surface and an interior wall surface. The system includes: a first acoustic transducer mounted on the exterior wall surface, the first acoustic transducer mounted and configured to transmit an acoustic excitation signal through the solid wall towards the interior volume of the container; and a data processing system configured to process data representing a received acoustic response signal received at a location on the exterior wall surface, the acoustic response signal having traveled through the solid wall and being responsive to the excitation signal, the data processing system further configured to distinguish gas from liquid contents within the container based on the processing of the data from the received acoustic response signal.

According to some embodiments, first acoustic transducer is formed of a piezoelectric ceramic material and is part of a first acoustic transducer unit comprising two electrodes, a backing layer, and a permanent magnet configured to securely hold first acoustic transducer unit against the exterior wall of the container.

According to some embodiments the system further includes second and third acoustic transducers. The first, second and third acoustic transducers are mounted so as to be separated from each other in a vertical direction. According to some embodiments, the system further includes a telemetry unit configured to transmit an alarm to a surface facility when a predetermined threshold value relating to water ingress into the buoyancy tank is met.

### BRIEF DESCRIPTION OF THE DRAWINGS

The subject disclosure is further described in the detailed description which follows, in reference to the noted plurality of drawings by way of non-limiting examples of embodiments of the subject disclosure, in which like reference numerals represent similar parts throughout the several views of the drawings, and wherein:

FIG. 1 illustrates a subsea oil and gas field architecture in which some embodiments are used;

FIG. 2-1 is a diagram illustrating multiple reflections and transmissions of a short acoustic pulse within the buoyancy tank wall, according to some embodiments;

FIG. 2-2 is a diagram showing ring-down and pulse-echo responses in a buoyancy tank, according to some embodiments;

FIGS. 3-1 and 3-2 illustrate a layout for a transducer array module and housing, according to some embodiments;

FIGS. 4-1 and 4-2 show perspective and semi-exploded views respectively, of a quad package 362 of transducers, according to some embodiments;

FIG. 4-3 is and exploded view of another transducer array module, according to some embodiments;

FIG. 5 illustrates a horizontal cross-section through a transducer array module, according to some embodiments;

FIGS. 6-1 and 6-2 are perspective views showing a buoyancy tank with transducer arrays clamped to each ballast tank, according to some embodiments;

FIG. 7 is a diagram illustrating aspects of calibration for a system for non-invasively acoustically monitoring containers to distinguish gas contents from liquid contents, according to some embodiments;

FIG. 8 is a diagram illustrating aspects of in-situ calibration for a system for non-invasively acoustically monitoring containers to distinguish gas contents from liquid contents, according to some embodiments;

FIG. 9 is a diagram illustrating aspects of non-invasively acoustically measuring water or liquid levels in containers, according to some embodiments;

FIG. 10 is a flow chart showing aspects of water level measurement taken periodically at a predetermined duty cycle, according to some embodiments;

FIGS. 11-1, 11-2 and 11-3 are diagrams illustrating aspects of a low-power procedure for non-invasively acoustically measuring water or liquid levels in containers, according to some embodiments;

FIG. 12 is a flowchart illustrating aspects of a low-power procedure for non-invasively acoustically measuring water or liquid levels in containers, according to some embodiments;

FIG. 13 is a flow chart showing aspects of a procedure for a mixed measurement approach, wherein timing is controlled by individual TAMs, according to some embodiments; and

FIG. 14 is a diagram illustrating aspects of pulse-echo response measurement, according to some embodiments.

### DETAILED DESCRIPTION

The particulars shown herein are by way of example, and for purposes of illustrative discussion of the embodiments of the subject disclosure and are presented in the cause of providing what is believed to be the most useful and readily understood description of the principles and conceptual aspects of the subject disclosure. In this regard, no attempt is made to show structural details of the subject disclosure in more detail than is necessary for the fundamental understanding of the subject disclosure, the description taken with the drawings making apparent to those skilled in the art how the several forms of the subject disclosure may be embodied in practice. Further, like reference numbers and designations in the various drawings indicate like elements.

According to some embodiments, acoustic devices are installed as periodic or continuous control of the water level in the section(s) of the buoyancy means.

According to some embodiments, the acoustic devices are clamped to existing and/or future buoyancy means as periodic or continuous control of the water level in the section(s) of the buoyancy means.

According to some embodiments, the buoyancy means is a buoyancy tank. In one embodiment, permanent acoustic devices are clamped buoyancy tanks as an in-situ measurement of the water level in each section of the tank.

According to some embodiments, the permanent acoustic devices include at least one array of acoustic transducers clamped to the buoyancy tank by permanent magnets and straps with one or several transducer arrays in each section. At installation, the array of acoustic transducers can be placed above the internal water level in the buoyancy tank, and periodic measurements can be performed to determine the presence and in addition the rate of water ingression as the water level passes the sensor. According to some embodiments, an alarm is triggered by any means (such as a specific signal from an acoustic transponder) if the water ingression rate surpasses a predetermined limit.

According to some embodiments, the acoustic transducers have a local electronics board comprising a microprocessor configured to excite the active transducers, listen to the passive transducers, and store data for flow-rate estimation. A central unit may manage data telemetry and feed power to the transducers.

According to some embodiments, the array of acoustic transducers has a flash memory or equivalent device to store full data sets for possible post analysis when alarm is triggered for water ingression events.

According to some embodiments, the array of acoustic transducers is connected to the other units by two connectors and cables of predetermined length and can communicate with a single bus to the central unit.

According to some embodiments, the array of acoustic transducers is embedded in packaging made of non-galvanic material.

According to some embodiments, the buoyancy means comprise a buoyancy tank with a plurality of compartments and the system comprises a series of array of acoustic transducers being deployed against the buoyancy tank, one per compartment close to the bottom of it in a place where initially no water is present.

According to some embodiments, low power consumption of the system enabled by a distinction between signal processing and duty cycle at the level of each array.

According to some embodiments, a method of acoustically monitoring integrity of a floating unit having buoyancy means is described. The method includes providing at least one array of acoustic transducers secured to the buoyancy means wall; firing the at least one array of acoustic transducers by an acoustic pulse exciting at least one array of acoustic transducers such that the excitation signal is reflected at the buoyancy means wall and analyzing the reflected signal on the buoyancy means wall to determine occurrence of external fluid invasion inside the buoyancy means.

According to some embodiments, the method includes periodic monitoring of the possible fluid invasion in front of the lowest one of the array of acoustic transducers. According to some other embodiments, when no water is present, the array of acoustic transducers can go to sleep up to the next watching period. According to some embodiments, the duty cycle can be adjusted according to predetermined time sets.

According to some embodiments, when fluid invasion is detected at the level of the lowest of the array of acoustic transducers, an alarm can be sent to the central unit and a shorter duty cycle can be triggered to accurately monitor the water level progression along the array.

According to some embodiments, the time duration between two time sets is adjusted a priori to cover a maximum fluid invasion flow-rate.

According to some embodiments, the speed of fluid ingression can be recorded such that a predictable ingression profile of the buoyancy means can be provided.

According to some embodiments, the method includes performing periodic measurement of the resonant behavior of a steel wall of the buoyancy means and providing measurement of internal corrosion of such steel wall from determination of a shift in the resonant frequencies of such steel wall.

A description of general principle relating to some embodiments will now be provided.

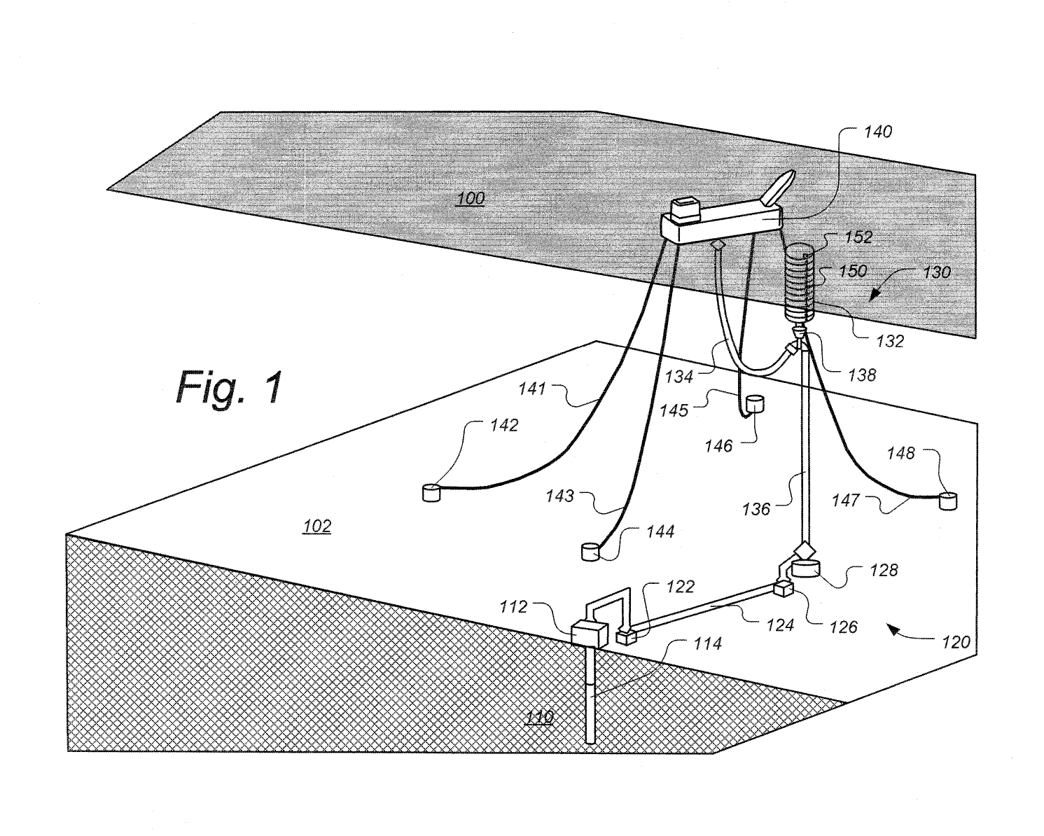

FIG. 1 illustrates a subsea oil and gas field architecture in which some embodiments are used. The subsea and gas field architecture shown integrates a pipeline network 120 to transport production fluid from the wellhead 112 on the seafloor 102 to the surface facilities on the sea surface 100. Wellhead 112 draws production fluid from subterranean rock formation 110 via wellbore 114. In the example shown in FIG. 1, the production fluid flows along sea floor flowline 124 which is terminated by pipe termination 122 one end and by spool piece 126 on the other end. As part of pipeline network 120 a riser pipe structure 130 is provided close to the surface process facilities to lift the fluid from the seabed 102 to the surface 100. In some examples of this network 120, for deep and ultra-deep water, operators have adopted a hybrid free standing riser architecture which comprises: seabed riser anchor base 128; a vertical single or bundled riser pipe(s) 136 anchored to the seabed anchor base 128; a buoyancy tank 132 providing an uplift tension to vertical riser pipe(s) 136; a flexible pipe 134 connecting the top of the vertical riser 136 to the surface process facilities (FPSO) 140; and a flexible joint 138 for connecting the buoyancy tank 132 to the vertical riser 136. FPSO 140 is anchored using mooring lines 141, 143, 145 and 147 to suction anchors 142, 144, 146 and 148 respectively.

Accidental flooding of the buoyancy tank 132 could create a potential hazard to the riser system 130 and expose the field to a risk of catastrophic failure if a sufficient uplift tension is not applied to the vertical pipe system 136. In order to mitigate this risk, instrumentation can be installed to monitor possible accidental flooding of the buoyancy tank 132. Additionally, the buoyancy tank 132, in the case shown is divided into a vertical stack of several independent compartments to limit the amount of water that could accidentally fill in the tank.

When buoyancy means, such as buoyancy tank 132, are immersed at depth greater than the conventional depth of human intervention (i.e. greater than 100 meters) the use of Remotely Operated Vehicles (ROVs) allows operations around submersed devices, such as sensor deployment and telemetry plugging.

According to some embodiments, a device array 150 made of several acoustic sensors is clamped with magnetic links to the external envelope of the buoyancy tank 132. The buoyancy tank 132 structure is acoustically excited and the acoustic response is listened to, allowing detection of the presence and/or level of water behind the tank wall, possibly limiting the upward tension force provided to the riser 136 by the buoyancy tank 132.

According to some embodiments, the detection is achieved by analyzing the response to an acoustic excitation signal, which will exhibit different characteristics depending on the medium on the opposite face of the buoyancy tank wall that is often made of steel. The difference arises in part from the difference in the acoustic reflection coefficient of a steel-water and steel-air interface. According to some embodiments, a vertical array of transducers 150 allows the water level to be determined by analyzing which transducers are adjacent to water, which are adjacent to air, and which adjacent to a water/air interface.

When the buoyancy means comprise buoyancy tanks, such as tank 132, that are segmented into individual ballast tanks, at least one transducer array may be used for each ballast tank. A central control unit 152 provides management of the signals coming from each transducer array and handles external telemetry by sending the current status and alarm signals to an operation center.

According to some embodiments, internal or external power means (for example batteries) supply power used by the sensor electronics, for firing the transducers, for signal measurement, and for internal telemetry to relay the information to a piloting system.

Monitoring of individual compartments of tank 132 enables more precise information regarding the nature of any ingression than is possible with a conventional tension measurement system. For example, a conventional tension measurement cannot differentiate between 1 ton of ingression in a single compartment and 0.2 ton of ingression in 5 compartments. The particular compartment(s) where the ingression is occurring can also be identified immediately, without additional diagnostic equipment.

The system described according to some embodiments provides improved sensor design combining water level detection and rate of the water level over a given period of time.

Further details with respect to the principles of the measurement will now be provided.

According to one embodiment, the buoyancy means is a buoyancy tank made of several cylindrical vertically stacked tanks each having a height dimension (h) of about 3 meters, and a diameter (d) of about 6 meters. The tank walls are made of coated stainless steel of thickness (e) which can be about 15 mm.

The bouyancy tank sections are normally substantially empty from water, but the tank may be exposed to gradual leaks due to corrosion for instance or any other reasons that may result in a gradual ingression of water into the tank. Since the tank is approximately vertical and have very slow motion the invaded water layer, if present, may be stratified at the bottom of a section, with a free surface at the height (f) from the bottom tank filled out with sea water then leaving a layer of air of height (h-f).

A measurement of water ingression can therefore be performed by measuring the water level with an acoustic transducer placed near the bottom of each tank. Water ingression might appear as a gradual change in the acoustic response measured by the transducer.

Acoustic Behavior.

The acoustic impedance Z, defined as the product of density (ρ) and sound velocity (C) of the medium, is written for water and plane waves in

$$Rayls = \frac{kg}{s} {m}^{2}$$

For water, ρ_{w}≈1000 kg/m3 and C_{w}≈1500 m/s, so

Z_{w}=ρ_{w}C_{w}≈1.5 MRayls, 2

and at atmospheric conditions for air, ρₐ=1.29 kg/m3 and Cₐ=333 m/s, so:

Zₐ=ρₐCₐ≈430 Rayls 3

The value of Zₐ depends on temperature and pressure, but the influence of these changes on the acoustic behavior of the system is negligible.

Finally, for steel, ρₛ≈7800 kg/m3 and Cₛ≈6000 m/s, so acoustic impedance of metal (steel) for plane waves is:

Zₛ=ρₛCₛ≈47 MRayls 4

The reflection and transmission coefficient amplitudes at the interface between two media (1, 2) are given as:

$${R}_{12} = \frac{{Z}_{2} - {Z}_{1}}{{Z}_{2} + {Z}_{1}} = 1 - {T}_{12} , {T}_{12} = \frac{2 {Z}_{2}}{{Z}_{2} + {Z}_{1}} . \qquad 5$$

The reflection coefficient of a steel-water interface is hence approximately 93.8%, while a steel-air interface is very close to 100%.

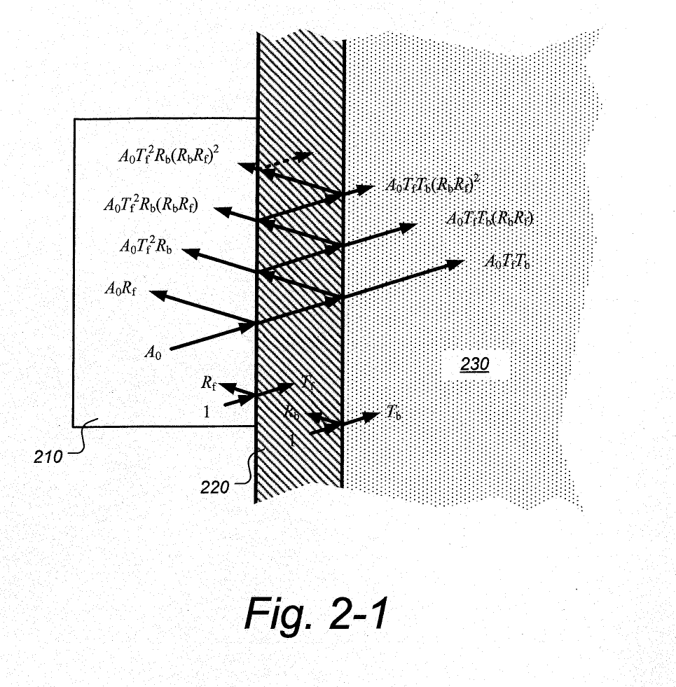

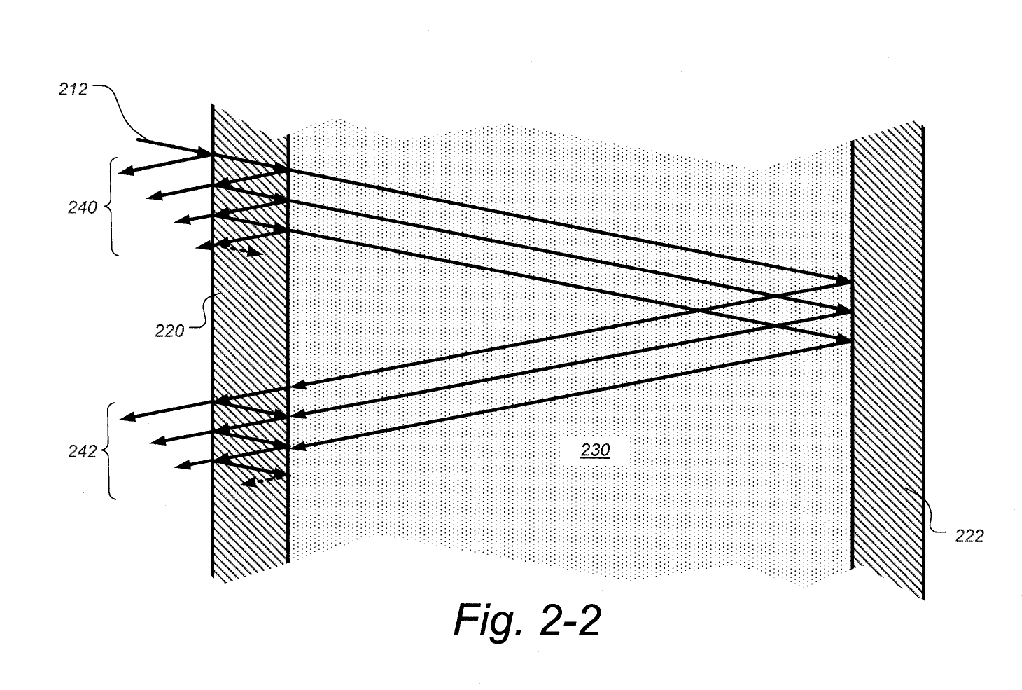

FIG. 2-1 is a diagram illustrating multiple reflections and transmissions of a short acoustic pulse within the buoyancy tank wall, according to some embodiments. When a short acoustic pulse with initial amplitude A₀ is sent from a transducer 210 clamped to the wall 230 of a buoyancy tank, the pulse undergoes multiple reflections within the steel wall, reducing its amplitude upon each reflection. Some of the acoustic energy enters the tank volume 230 as shown. The reflected acoustic pulses are detected when they are transmitted back into the transducer, and the amplitude of these pulses decreases by R_{b}R_{f} each time. Certain frequencies cause resonance within the steel wall, and after the drive signal is switched off, an acoustic signal will be emitted from the wall, gradually decaying as a characteristic ring-down signal, which is described in further detail herein.

Measurement Approaches.

According to some embodiments, the measurement system enables the determination the value of R_{b}, either directly or indirectly, and interprets this value so as to determine whether air or water is present at the opposite face of the steel wall. There are numerous ways to achieve this goal, some of which will now be described.

Short Pulse Measurement.

A short pulse measurement can be achieved by sending a delta or voltage step from a high-frequency, highly damped transducer, and measuring the resulting signal at high speed. In this way, the amplitude of each subsequent reflection is measured: A₀R_{f}, A₀T_{f}²R_{b} and A₀T_{f}²R_{b}(R_{b}R_{f}). This gives three equations and three unknowns (as T_{f}=1−R_{f}), allowing R_{b} to be calculated directly.

Single-Point, Single Transducer Ring-Down.

This example uses a short, single-frequency burst as a drive signal to the transducer. Certain frequencies cause resonance within the steel wall, and after the drive signal is switched off, an acoustic signal will be emitted from the wall, gradually decaying as a characteristic ring-down signal. In this particular approach, the power of the emitted acoustic signal is measured after a set time. If water is present on the opposite face, then this signal will be lower than if air is present. This approach is thus an indirect measurement of R_{b}.

Dual-Point, Single Transducer Ring-Down.

This example is similar to the previous one, except that the signal is measured at two times. The ratio of these two signals thus gives an estimate of the speed of the decay, independent of the absolute transducer response. The decay is faster when water is present, compared to air.

Single-Point, Dual Transducer Ring-Down.

This approach is similar to the single-point, single-transducer ring-down, except that the signal is sent from one transducer and measured by an adjacent transducer. In this case, the measured signal is one that spreads out laterally within the wall as it undergoes multiple reflections. The transducers can be positioned horizontally, ensuring that both transducers are likely to be equally adjacent to water. This approach simplifies the measurement electronics and enables the measured signal to undergo many reflections, which increases the contrast between the ‘air’ and ‘water’ signals.

Dual-Point, Dual Transducer Ring-Down.

This example uses the dual-point approach to measure the decay rate independently of transducer response, and simplifies the measurement electronics by using separate transducers.

Pulse-Echo.

This example uses a long, single-frequency burst as a drive signal to the transducer. Frequencies that cause resonance within the steel wall are preferentially passed through the wall, and the resulting acoustic wave then echoes off internal structures within the buoyancy tank, or indeed the opposite wall of the tank. FIG. 2-2 is a diagram showing ring-down and pulse-echo responses in a buoyancy tank, according to some embodiments. The sound pulse 212 enters the first steel wall 220 which generates the ring-down signal 240. Some of the acoustic energy travels through the tank volume 230, which is either air or water, and is reflected off of the opposite tank wall 222. When the energy reaches the first wall 220 it generates the pulse-echo signal 242. Note that the ray paths are drawn at an angle in FIG. 2-2—for clarity. In this approach, the power of the emitted acoustic signal is measured after a set time corresponding to the expected distance to the internal structure. If water is present inside the tank, then the acoustic wave can pass through the wall and a strong echo will be detectable after a delay corresponding to the speed of sound in water. If air is present, then the wave cannot easily pass through the wall and a relatively weak echo signal can be detected after a delay corresponding to the speed of sound in air. Thus, when water is present in volume 230, the ring-down signal is relatively weak and decays more quickly, while the pulse-echo signal is relatively strong. When air is present in volume 230, the ring-down signal is relatively strong and decays more slowly, while the pulse-echo signal is relatively weak. It has been found that using a combination of ring-down and pulse-echo measurement techniques can be highly beneficial for many applications. For example, it has been found that using a combination of ring-down and pulse-echo measurement techniques allow for substantially lowering false alarm occurances.

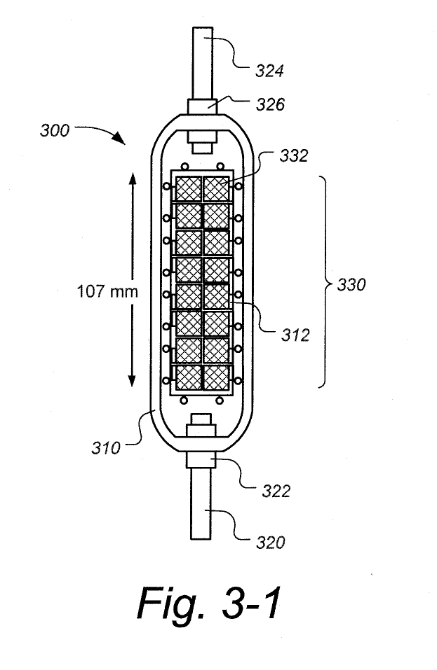

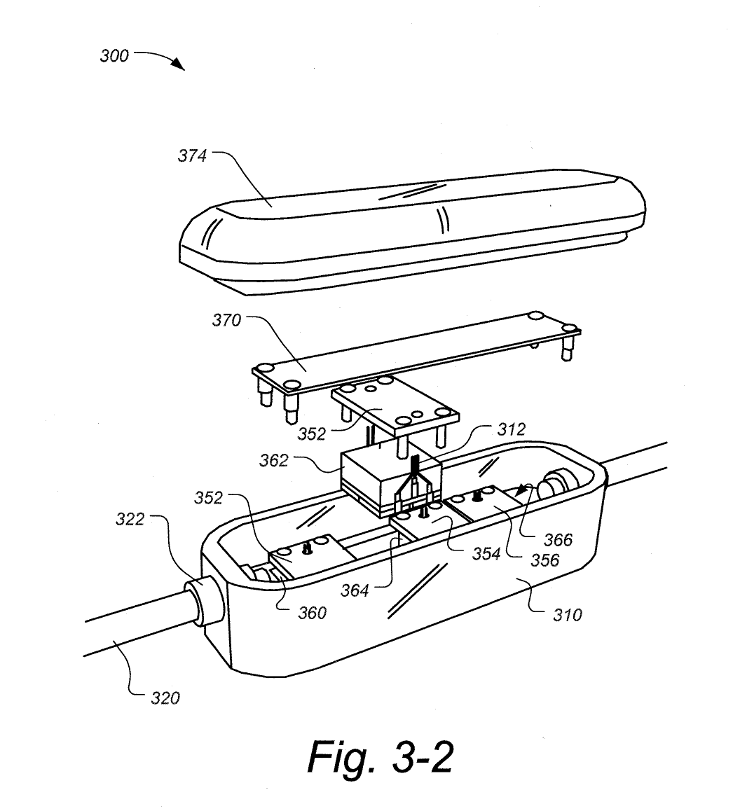

FIG. 3-1 illustrates an array of transducers used for estimation of water ingression flow-rate, according to some embodiments. N adjacent square or rectangular transducers of height a are arranged in a vertical array at locations (z₁, z₂, zᵢ, . . . z_{N}). In the case shown in FIG. 3-1, N=16. A rough measurement of the position of the water interface is possible by simply observing which sensors measure air and which sensors measure water. According to some embodiments, a more accurate measurement of the water interface is also possible by measuring the transducer which is partially covered (i.e. the location adjacent to the transducer is partially covered) by water and estimating the percentage coverage, based on a linear change in the measured signal from complete air to complete water.

The cross-sectional area of a buoyancy tank with a diameter of d=6 m is

$${S}_{BT} = π \frac{{d}^{2}}{4} = 28 {m}^{2} .$$

An example sensor array 10 cm high will be able to detect 2.8 tons of water ingression in this case. The maximum rate of water ingression that can be measured might limited by the duty cycle of the measurement system: a once-per-hour measurement, for example, would be able to detect ingression rates of up to 2.8 tons/hr.

Examples are described infra of transducer shapes and connections between sensors, the signal processing and an example of the duty cycle of the proposed system.

According to some embodiments, a series of Transducer Array Modules (TAMs) are clamped to the walls of individual ballast tanks by permanent magnets. Each TAM might be controlled with on-board electronics module that control the drive signals, measurement, signal processing and telemetry with a central unit. The central unit can receive measurements from each TAM and handle external telemetry. The individual TAMs can be connected together with a multi-wire cable that carries power, ground and data wires. The cable can be a single multi-drop cable with one connection to each TAM, or made up of short cable sections with two connections to each TAM. FIGS. 3-1 and 3-2 illustrate a layout for a transducer array module and housing, according to some embodiments. The design shown in FIGS. 3-1 and 3-2 can be used for a dual-transducer measurement approach described supra, where the signal is sent from one transducer and measured on a horizontally adjacent transducer. In one example shown in FIG. 3-1, TAM 300 has a layout array 330 of sixteen (arranged 8×2) 12.5-mm square transducers 332, two cables 320 and 324, and housing 310. The cables 320 and 324 pass through the sealed housing 310 via feedthroughs 322 and 326 respectively. Further, each transducer 332 of the array 330 can be made of a piezoelectric ceramic, two electrodes, a backing layer, and a permanent magnet to clamp the transducer against the metallic buoyancy tank wall.

FIG. 3-2 shows a semi-exploded view showing further details of the transducer packaging, according to some embodiments. For ease of manufacturing and to create a compact module, according to some embodiments, four transducers are grouped together with a backing, magnet, electrodes and wiring to create a quad transducer package. The quad packages 360, 362, 364 and 366 can be assembled outside of the housing and then clamped into place using, for example, a steel support. FIG. 3-2 shows a semi-exploded view detailing how these quad packages are positioned into the TAM 300. The quad packages 360, 362, 364 and 366 are held in place using steel supports 350, 352, 354 and 356 respectively. A PCB 370 with various electronics is provided which is electrically connected to each of the quad packages and the transducers. The TAM 300 is sealed via housing 310 and upper lid 374.

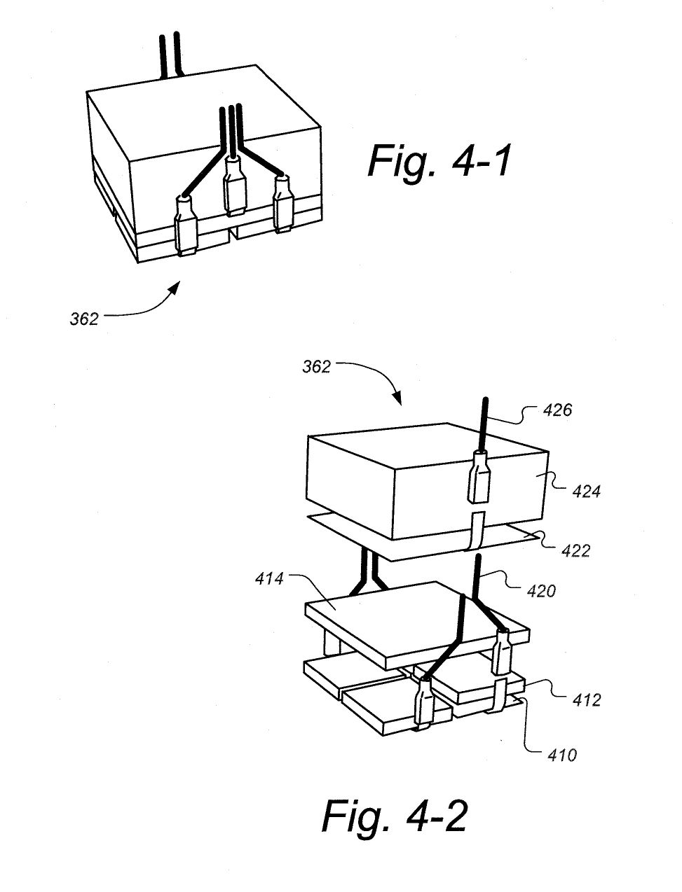

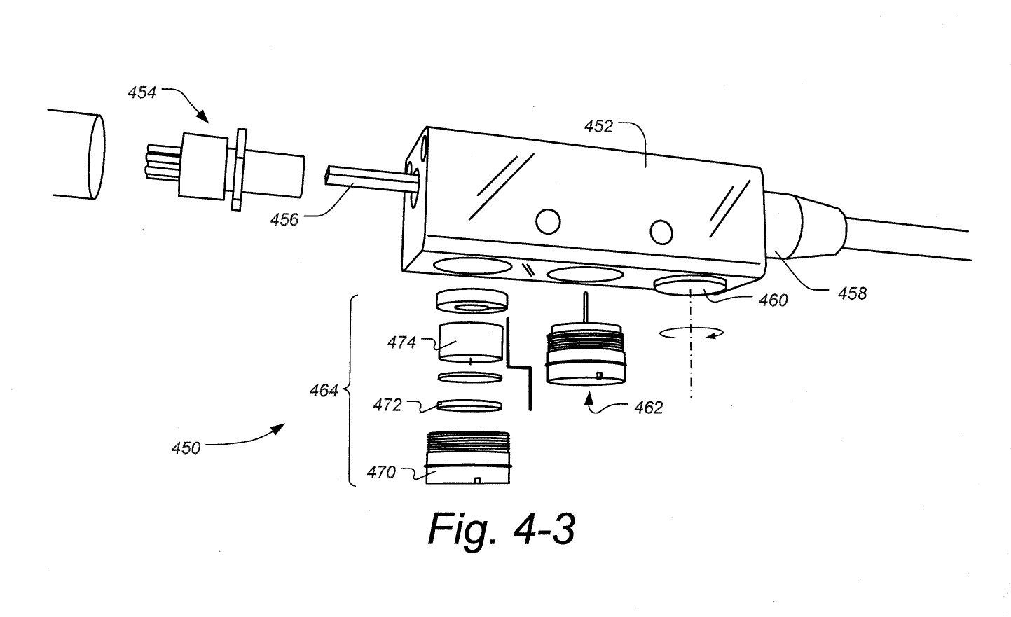

FIGS. 4-1 and 4-2 show perspective and semi-exploded views respectively, of a quad package 362 of transducers, according to some embodiments. It has been found to be beneficial to use a sintered stainless steel backing 414, which provides acoustic isolation from the magnet 424 and light damping of the transducer 412, while remaining extremely thin and structurally rigid. The use of this material is discussed in U.S. Pat. No. 4,420,707 filed in December 1983. As the backing 414, ceramic transducer 412 (including housing wall) are relatively thin, the magnet 424 can be placed behind the transducer 412 and still provide a strong magnetic clamping force. Also shown in FIG. 4-2 is the active electrode 410, active wire 420, ground electrode 422 and ground wire 426. A compact design is thus provided along with a relatively strong transducer clamping force to the wall. Each individual array can be mounted inside packaging (e.g. plastics, metal, etc.) to make up a series of transducers according to different possible embodiments corresponding to several possible methods of measurement, including: i) Short pulse measurement, Single-point; ii) single transducer ring-down; iii) Dual-point, single transducer ring-down; iv) Single-point, dual transducer ring-down; and/or v) Dual-point, dual transducer ring-down.

FIG. 4-3 is an exploded view of another transducer array module, according to some embodiments. In this example, the TAM 450 includes three separate transducer assemblies 460, 462 and 464 that are housed in an all-plastic housing body 452. The use of plastic in the design has been found to minimize both corrosion and weight. The electrical cables are connected via a dry-mate bulkhead connectors 454 and 458. The individual sensor electronics are housed in a PCB 456. Each of the transducer assemblies 460, 462 and 464 are screw mounted into the housing body 542. The transducer assembly 464 is shown in an exploded view for clarity. It includes a transducer body 470, piezoceramic tranducer 472 and magnet 474. The magnet 474, according to some embodiments is a rare earth magnet so as to ensure each transducer assembly is strongly clamped to the tank.

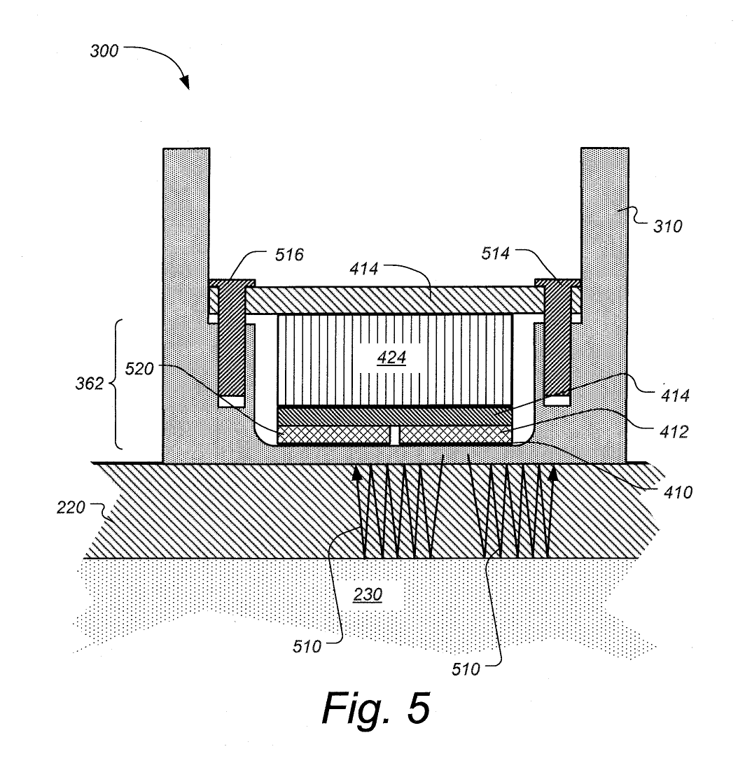

FIG. 5 illustrates a horizontal (with respect to a vertical ballast tank) cross-section through a transducer array module, according to some embodiments. The TAM 300 also illustrates the dual transducer approach, described supra. In this figure, the cross-section through a pair of transducers (looking down when attached to a ballast tank), shows the materials and a dual-transducer measurement technique, according to some embodiments. Specifically, quad package 362 of transducers is secured to non-metallic housing 310 via steel support 414 and support screws 514 and 516. The transducer 412 is acting as the transmitter, and the transducer 520 is acting as the receiver. The horizontal spreading of the acoustic signal is illustrated by ray paths 510 and 512.

FIGS. 6-1 and 6-2 are perspective views showing a buoyancy tank with transducer arrays clamped to each ballast tank, according to some embodiments. Buoyancy tank 132 is made up of multiple cylindrical ballast tanks such as ballast tanks 610 and 612. An acoustic modem, battery pack 620, and central control unit 630 are mounted on top of tank 132. The cable 622 provides power, ground and data communications to each of the TAMs. Each TAM is positioned near the base of each ballast tank. For example, TAMs 450 and 614 are shown positioned near the base of ballast tanks 610 and 612 respectively. The acoustic modem and battery pack 620 provide telemetry, for example to FSPO 140 (shown in FIG. 1). According to some embodiments, the architecture of the TAMs is a daisy chain wherein power is connected the chain periodically (e.g. once per hour). Each TAM measures and returns status to the central control unit 630. The central unit 630, in turn, sends status to the surface via acoustic telemetry unit 620. For mounting the TAMs to tank 132, a ladder approach is shown in FIGS. 6-1 and 6-2. Semi flexible or fully flexible cables 624 and 626 run the length of the tank 132. Flexible arms such as arm 640 are used to position the TAMs relative to each ballast tank.

According to some embodiments, an ROV (not shown) can be used to deploy the chain of sensors pre-connected to a central control unit, and connect them to an acoustic modem to communicate with the surface.

Calibration.

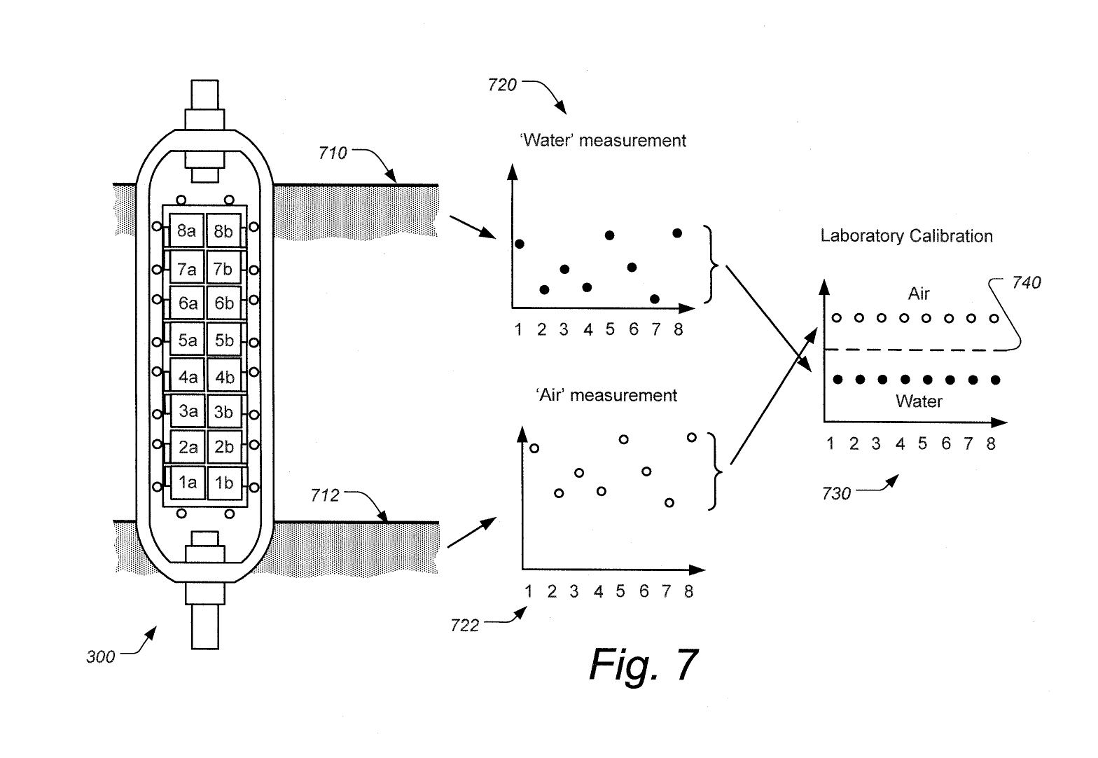

FIG. 7 is a diagram illustrating aspects of calibration for a system for non-invasively acoustically monitoring containers to distinguish gas contents from liquid contents, according to some embodiments. As discussed, supra, an example of an acoustic measurement approach, works by determining the reflection coefficient of the back face of the steel wall either directly with a high-speed measurement or indirectly with a ring-down approach. The described measurement approaches return a single number that relates to the reflection coefficient. The challenge in implementing a water-level measurement system using the acoustic approach is in determining the expected values of the measurement for both the water and air cases. This expected value might be affected by aspects such as surface roughness, small changes in thickness, quality of the front interface, variation in transducer response, and possibly other factors. Following is a description of how calibration and water level measurement can be achieved with the single-point, dual-sensor approach described supra, according to some embodiments. According to other embodiments, similar approaches can be used for the other measurement techniques.

According to some embodiments, an initial laboratory calibration is performed to ensure that all transducers respond identically and to determine the expected values for the ‘air’ and ‘water’ cases with a representative sample of a steel wall. This task can be performed before deployment in a laboratory setting, where measurements can be taken in water and air. During this laboratory calibration, the frequency of the drive signal can be varied to find the maximum response. As shown in FIG. 7, a TAM 300 is in the laboratory and is tested with all transducers adjacent to water (at water level 710), and all transducers adjacent to air (at water level 712). For the water measurement (at water level 710), the plot 720 shows the initial un-calibrated response for each of the transducer pairs of TAM 300. Likewise, for the air measurement (at water level 712), the plot 722 shows the initial un-calibrated response. The plot 730 shows the calibrated response for both the water and air measurements for each of the transducer pairs. This can be performed using a simple scaling factor which can be recorded for each transducer to ensure that all transducers report the same measurement value under the same conditions. Additionally, a cut-off value 740 can be defined and determined as the midpoint between the ‘water’ and ‘air’ measurements (after calibration). Lastly, the ratio between the ‘air’ and ‘water’ measurements, k_{aw}, is also measured.

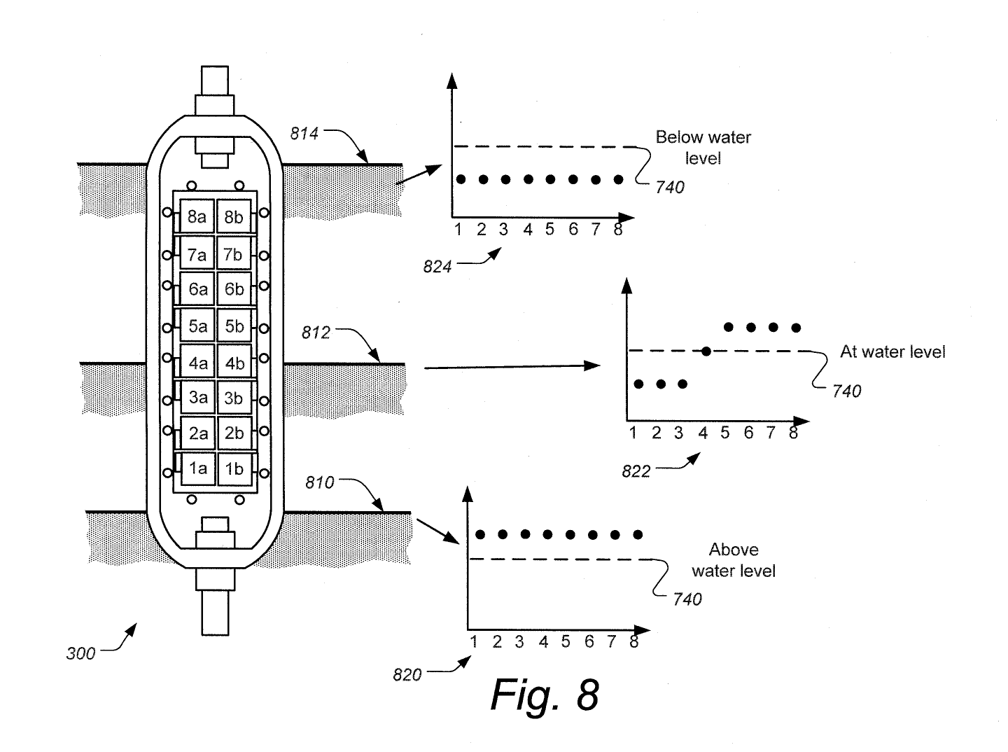

FIG. 8 is a diagram illustrating aspects of in-situ calibration for a system for non-invasively acoustically monitoring containers to distinguish gas contents from liquid contents, according to some embodiments. Once the system is deployed in the field, several possibilities exist for an individual TAM 300: (1) above internal water level; (2) at internal water level; or (3) below internal water level. The state of each TAM can be determined by comparing the measurement of each transducer in the array to the cut-off value 740 determined during factory calibration (illustrated in FIG. 7). These three possibilities are illustrated in FIG. 8. In particular, plot 820 shows the response in an above water level state (water level 810), plot 822 shows the response in an “at’ water level state (water level 812), and plot 824 shows the response at a below water level state (water level 814). Additionally, it has been found that there may also be a uniform shift in the response of the transducers to the ‘air’ and ‘water’ cases, arising from small differences in wall thickness, paint thickness, and possibly the water pressure on the transducer face, compared to the laboratory calibration. According to some embodiments, a fine calibration can be employed at this point to ensure that the measured response matches the factory calibration response. This can be undertaken for transducers in a known ‘water’ or ‘air’ state. According to some embodiments, at deployment all transducers are initially above the internal water line.

During the in-situ calibration, the drive frequency of the transducers may be shifted slightly to obtain the maximum response. The frequency that gives the maximum response is the one that causes standing wave resonance in the wall, which is linked to the wall thickness. A consequence of this in-situ calibration is the ability to make an indirect wall thickness measurement. According to some embodiments, the in-situ calibration can also function as in indirect measure of internal corrosion of the tank, since the thickness of the steel in the wall will change as it corrodes from the inside. According to some embodiments, this in-situ calibration procedure could be repeated periodically to monitor corrosion on the internal face of the tank.

Water Level Measurement.

According to some embodiments, measurement of the water level is performed with an array approach by exploiting the multiple measurements on the same steel wall to obtain an in-situ measurement of the expected signal levels for the ‘air’ and ‘water’ cases. The response of individual transducers below the water level are used to determine the ‘water’ signal level, and the response of transducers above are used to determine the ‘air’ signal level. According to some embodiments, a linear interpolation between these two extremes gives the water level at the one transducer that is partially submerged: for example, a signal halfway between the two levels indicates that the water level is halfway up the partly submerged transducer. A special case exists when the partly submerged transducer is at the top or bottom of the array—in this case, there will be one unknown level, which can be calculated from the ratio k_{aw} which can be determined during calibration. Note that as used herein referring to a transducer or transducers as “submerged” or “partially submerged” does not mean that the transducer or transducers are directly submerged or partially submerged, but rather means that the transducer or transducers are at an exterior location on the container wall that is directly adjacent to an internal location that is submerged or partially submerged.

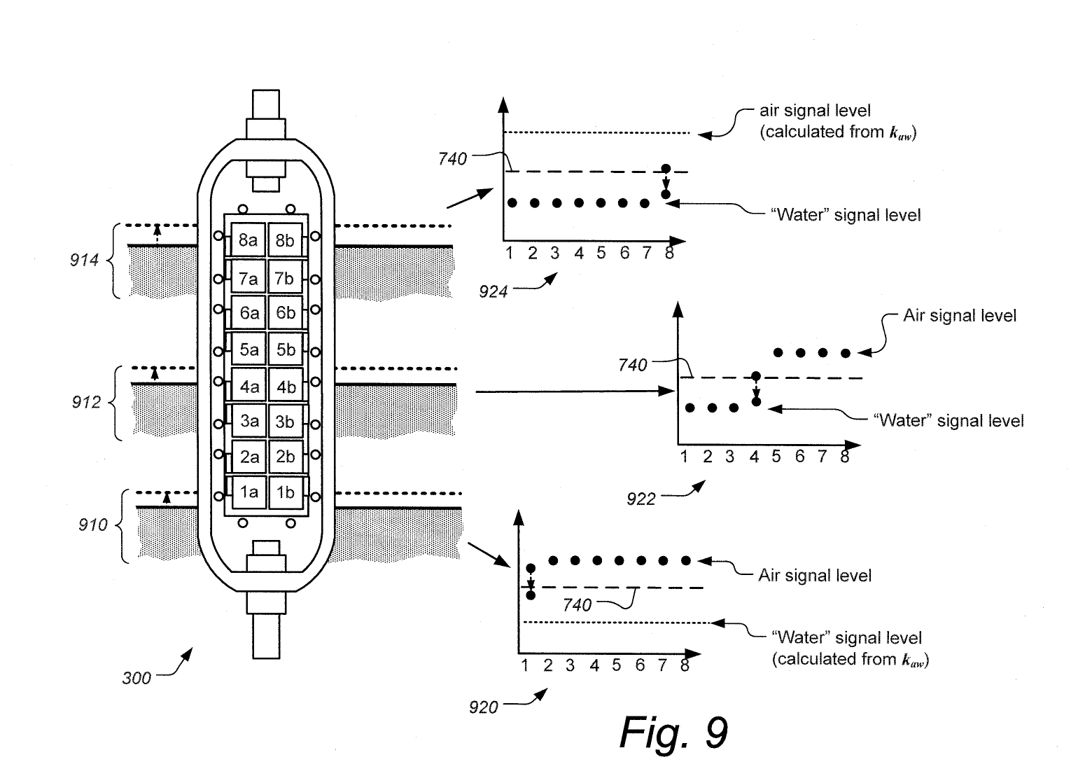

FIG. 9 is a diagram illustrating aspects of non-invasively acoustically measuring water or liquid levels in containers, according to some embodiments. As shown in FIG. 9, the measurement of water level is achieved by determining in-situ signal levels. In particular, the water level 910 with respect to TAM 300 represents a case where the water level is just below transducer pair number 1 (including transducer 1a and 1b) as indicated by the solid line and is rising to the dotted line which is at the level of those transducers. Plot 920 shows the transducer signals for the water level 910. It can be seen that transducer (or transducer pair) number 1 drops below the cut-off value 740, while the remaining signals from transducers (numbers 2-8) are at the air signal level. The water level 912 represents a case where the water level is rising from the middle of transducer pair 4 to just above that pair (shown by the solid line to the dotted line). Plot 922 shows the transducer signals associated with the water level 912. It can be seen that signal from transducer (or transducer pair) number 4 drops from the cut-off value 740 to near the water signal level. The signal from transducers 1-3 are at the water signal level, while the signals from transducers 5-8 are at the air signal level. The water level 914 represents a case where the water level is rising from the middle of transducer pair 8 to just above that pair (shown by the solid line to the dotted line). Plot 924 shows the transducer signals associated with the water level 914. It can be seen that signal from transducer (or transducer pair) number 8 drops from the cut-off value 740 to near the water signal level. The signal from the remaining transducers (numbers 1-7) are at the water signal level.

According to some embodiments, the water level at the partly submerged transducer can be determined by linear interpolation between the two levels. For a water signal level of S_{w}, an air signal level of Sₐ, a signal of Sₚ on the partly submerged transducer number nₚ, transducers with a vertical dimension of a and a gap between transducers of d_{g}, the height of water h_{w} relative to the bottom of the array is given by:

$${h}_{w} = a ( \frac{{S}_{a} - {S}_{p}}{{S}_{a} - {S}_{w}} ) + ( {n}_{p} - 1 ) ( a + {d}_{g} ) . \qquad 6$$

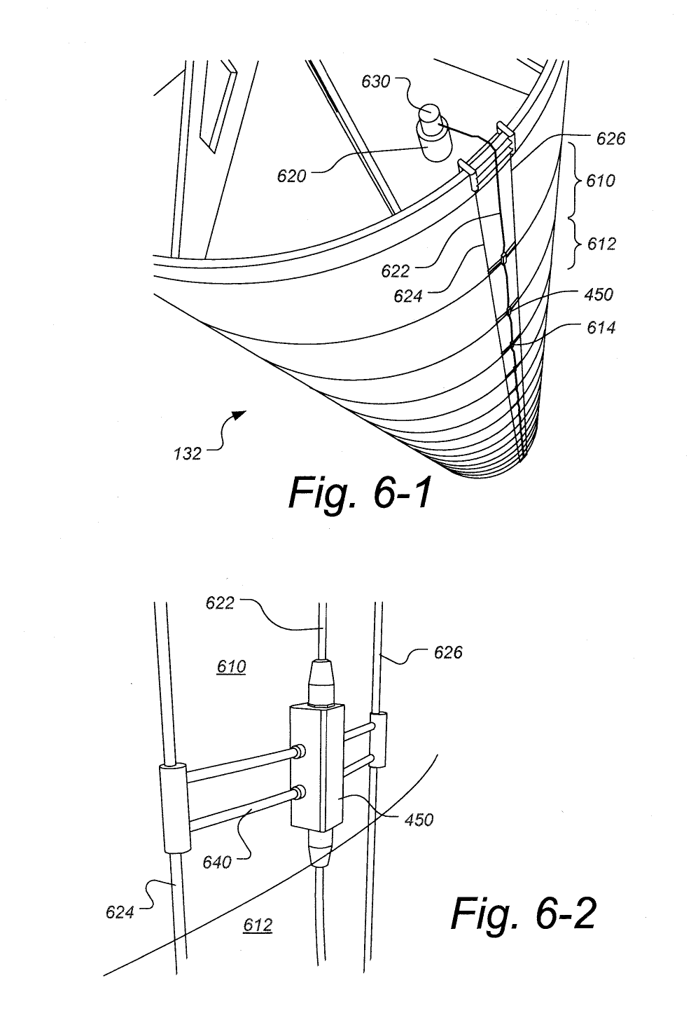

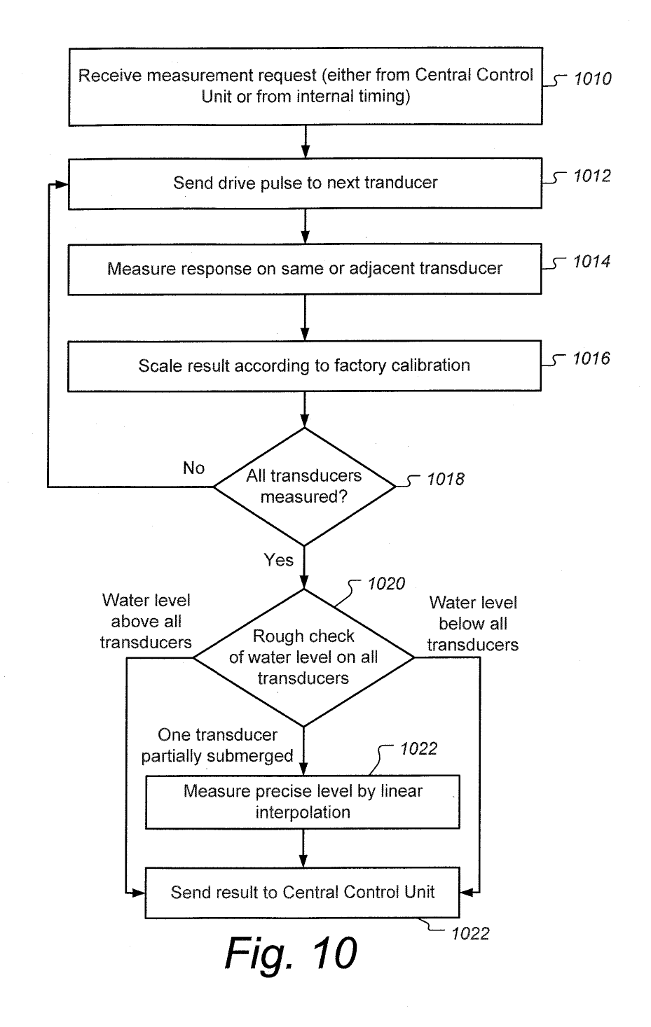

FIG. 10 is a flow chart showing aspects of water level measurement taken periodically at a predetermined duty cycle, according to some embodiments. In block 1010, a measurement request is received from a central control unit (e.g. unit 630 shown in FIG. 6-1) or from internal timing circuitry within the TAM. In block 1012, the drive pulse is sent to the first (or next) transducer. In block 1014, the response is measured at the same transducer, or in the case of transducer pairs, the adjacent transducer. In block 1016, the result is scaled according to the factory/laboratory calibration. In decision block 1018, when all transducers have been measured, control passes to block 1020. In decision block 1020, a rough check is carried out of water level for all the transducers. If one transducer (or pair) is partially submerged, then in block 1022 a measurement of a precise level is carried out using linear interpolation as described supra. If the water level is either above or below all the transducers, of after the linear interpolation, in block 1022 the results are transmitted to the central control unit (e.g. unit 630 shown in FIG. 6-1). The approach shown in FIG. 10 provides accurate information but does not incorporate techniques to conserve power. Measurement options that use less power are discussed in the following sections.

Low-power monitoring by binary level sensing. In the proposed application, low-power operation is sought, as the system is powered from a battery pack that can be accessed by ROV, for example. Power usage can be reduced by measuring one transducer from the array to monitor ingression, cutting down on the number of transducers that are measured each time. The power usage of the telemetry system to the surface (acoustic modem) is also considered, and so it may be desirable to only report changes in water level rather than a level measurement for every TAM, every time.

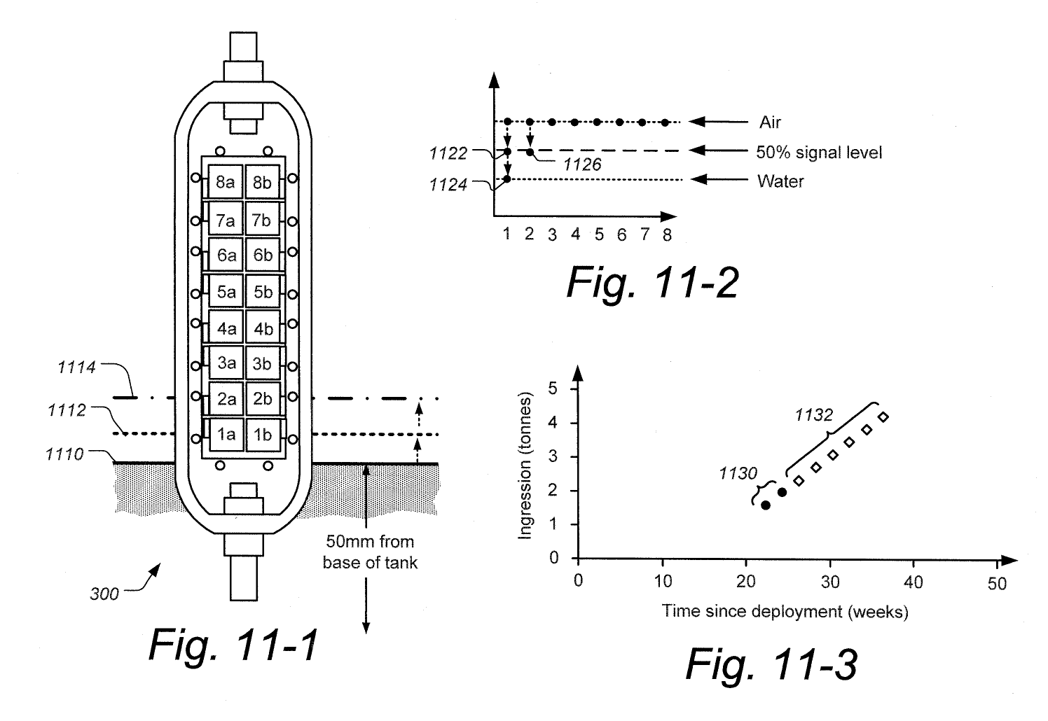

FIGS. 11-1, 11-2 and 11-3 are diagrams illustrating aspects of a low-power procedure for non-invasively acoustically measuring water or liquid levels in containers, according to some embodiments. The approach of FIGS. 11-1, 11-2 and 11-3 uses a specific point on each transducer as a binary level sensor. In FIG. 11-1, the water level rises from level 1110 which is 50 mm from the base of the ballast tank. At level 1112 an alert is triggered. In FIG. 11-2 the plot of transducer signals is shown. When the water level rises to level 1110 shown in FIG. 11-1, the signal from the transducer number 1 moves to point 1122, which is on the 50% signal level mark (corresponding to cut-off value 740). When the water level rises to the level 1112 shown in FIG. 11-1, the signals from transducers 1 and 2 move to points 1124 and 1126 respectively. At this point another alert is triggered. In each case, the alert is sent via external telemetry (e.g using an acoustic modem) to the surface. An operator on the surface then keeps a record of the time, TAM module and transducer number for any alert that arrives. FIG. 11-3 shows a plot for tracking and determining the rate of water ingression based on the time between successive alerts and the geometry of the system. The next transducer above the water level is monitored at any one time, and once an alert is triggered for a given transducer, the next highest transducer in the array could be monitored. The example illustrated in FIGS. 11-1, 11-2 and 11-3 use the 50% level as an example trigger level, a 190 L/week ingression that begins 21 weeks after deployment, for a TAM positioned with the bottom of the array 50 mm above the base of the tank. However, other trigger levels can be used according to other embodiments according to the application at hand.

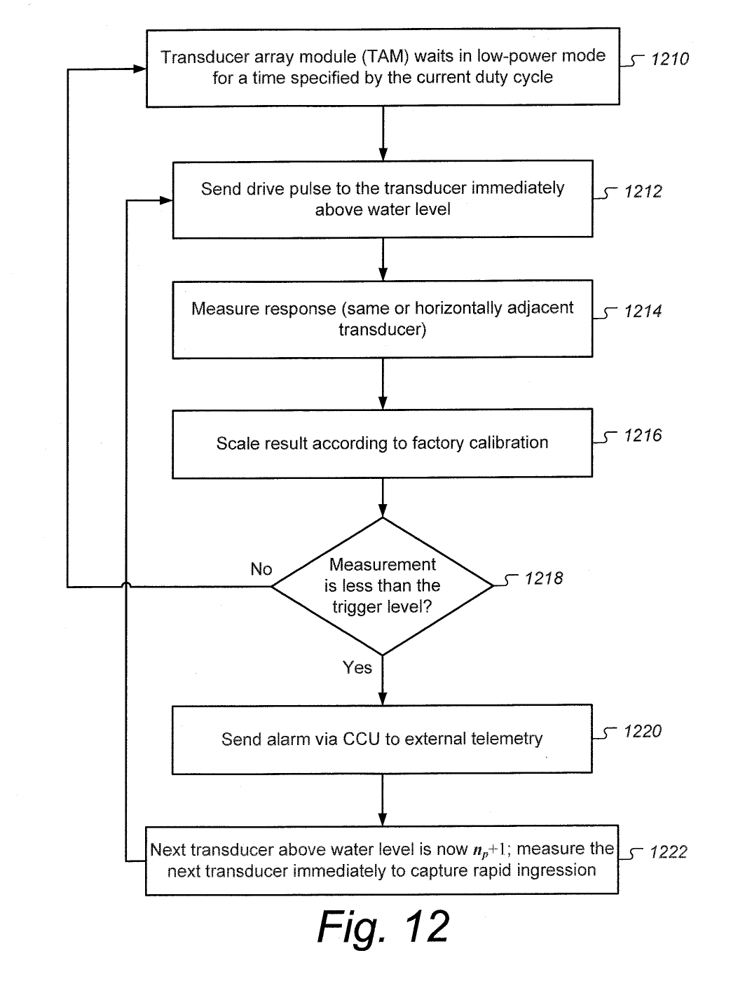

FIG. 12 is a flowchart illustrating aspects of a low-power procedure for non-invasively acoustically measuring water or liquid levels in containers, according to some embodiments. In FIG. 12, the individual TAMs control timing and the central control unit is used for relaying telemetry data externally (via acoustic modem). In block 1210, the TAM waits in a low-power mode from a time specification by the current duty cycle. In block 1212, the drive pulse is sent to the transducer immediately above the water level. In block 1214 the response is measured at the same transducer (or at the horizontally adjacent transducer in the case where transducer pairs are used). In block 1216 the result is scaled according to the factory/laboratory calibration. In decision block 1218, if the scaled signal level is less than the predetermined trigger level (e.g. cut-off value 740), then an alarm is sent to the central control unit (e.g. unit 630) and on to the surface using external telemetry (e.g. unit 620). If the scaled signal is not less than the trigger level then control returns to waiting state of block 1210. In block 1222, after an alarm is sent, the next transducer above the water level is updated, and that next transducer is immediately measured so as to capture the case of rapid ingression.

Mixed Measurement Approach.

According to some embodiments, a solution in terms of power usage and usefulness of the measurements is a mix of the level measurement and the low-power monitoring approach.

Under this mixed approach, the individual TAMs can monitor a single transducer at a relatively fast rate, once per hour for example. Measurements can be stored locally in a buffer, and used to estimate the current rate of ingression. If this ingression surpasses a set limit, an alarm can be triggered, sending the location of the TAM and the measured ingression rate. At an example of lower duty cycle (once per week for example), each TAM can perform a level measurement using all transducers, which can also act to re-set the current ‘water’ and ‘air’ levels, as well as verifying which transducer is at the current water level.

The maximum measurable rate of ingression can be determined by the internal duty cycle of the TAM and the geometry of the system. For this example, a once-per-hour duty cycle can be used for an array height of 107 mm and a surface area of 28 m², leading to a maximum measureable rate of about 3 tons/hr. The maximum rate can be increased by using a taller array or increasing the measurement rate. On the other hand, if the maximum ingression rate is faster than desired, then slowing the measurement rate would save power.

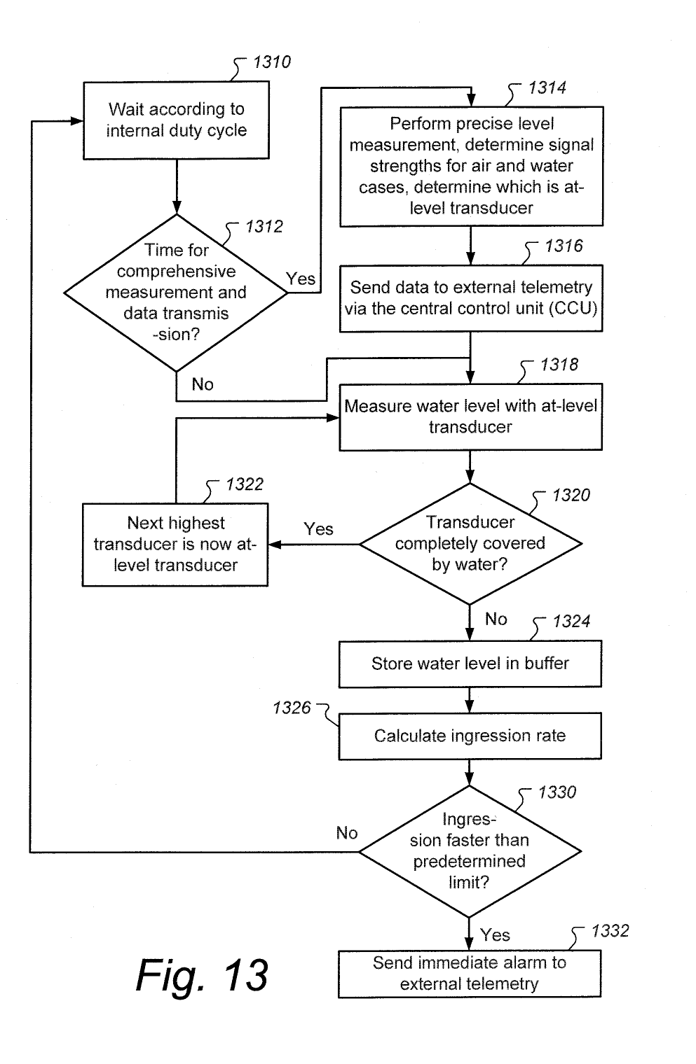

FIG. 13 is a flow chart showing aspects of a procedure for a mixed measurement approach, wherein timing is controlled by individual TAMs, according to some embodiments. In block 1310, the TAM waits according to an internal duty cycle. In block 1312, if it is time for comprehensive measurement and data transmission, then in block 1314 a precise level measurement is performed. The signal strengths for air and water are determined. Also, a determination of which transducer is currently at the water level is made. In block 1316, the data is sent to the surface via the central control unit and external telemetry. In block 1318, the water level signal for the current “at-level” transducer is measured. If the transducer is completely covered by water, in decision block 1320 then in block 1322 the transducer considered to be the current “at level” transducer is incremented to the next higher transducer. The measurement of the new “at level” transducer is then measured (again in block 1318). If the “at level” transducer is not completely covered, then the measured water level is stored in a buffer in block 1324. In block 1326, the ingression rate is calculated. In decision block 1330, if the ingression rate is greater than a predetermined limit then an alarm is immediately send to the surface via external telemetry. If the ingression rate is below the limit, the system re-enters to wait state of block 1310.

Influence of Cistern Waves.

When one of the ballast tanks is partially filled with a small amount of water below or close to the acoustic array location, a risk of motion of the free surface of water may disturb evaluation of the water level and its ingression flow rate. A rough approximation of the frequency of free surface plane waves (f=\sqrt{gh}/λ) provides a characteristic period of free surface waves of 6 sec for a wavelength of order of the flooding member of 6 meters with 10 cm of water. It can be expected that slow movements and basic background motion may induce natural vibrations inside the tank. These waves have a small amplitude and exhibit a sine wave characteristic.

To overcome the effect of cistern waves, the measurement approaches described supra can be changed by replacing each single measurement with two measurements separated by a predetermined time interval (for example 3 seconds apart, or half the sine wave period). The average of these two measurements gives the average water height.

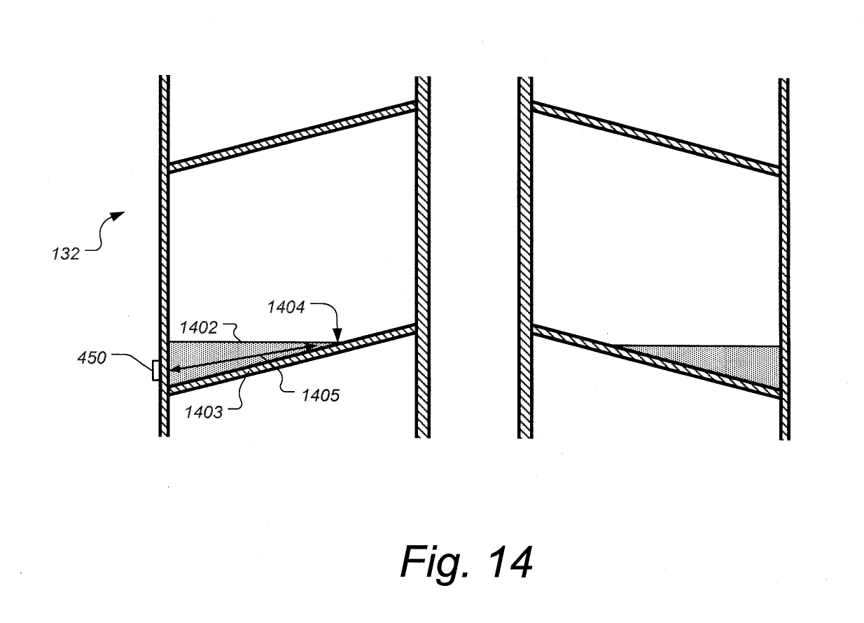

FIG. 14 is a diagram illustrating aspects of pulse-echo response measurement, according to some embodiments. It has been found that the interface between the floor of the tank and the rising water surface can be effectively used as an acoustic target for a pulse-echo measurement. In this approach, the interface between the water level 1402 and the inclined floor 1403 of the tank 132 acts as a sound reflector. An acoustic pulse sent from a transducer within TAM 450 and traveling along the path 1405 will undergo a strong reflection from the point 1404 and return to the transducer in TAM 450. The time between sending an acoustic pulse and receiving an echo is indicative of the distance between the sensor and the air-water interface 1404, allowing the internal water level 1402 to be calculated from the known tank geometry even when this water level is above the level of the transducer.

Although many of the embodiments have thus far been described with respect to monitoring of buoyancy tanks in subsea riser applications, the techniques described are also applicable in other settings. According to some embodiments, the techniques described may be applied to any application in which gas may be distinguished from liquid in a container, tank or reservoir non-invasively through a solid wall of the container, tank or reservoir. For example, the acoustic monitoring system described can be used to detect the water level in a metal water tank in a remote location. In another example, the acoustic monitoring system can be used in a chemical plant to measure the level of various liquid chemicals held in various containers.

While the present invention has been described in connection with a number of various embodiments, and implementations, the present invention is not so limited, but rather covers various modifications, and equivalent arrangements, which fall within the purview of the appended claims.

What is claimed is:

1. A method of non-invasively acoustically monitor contents of a container having a solid wall with an exterior wall surface and an interior wall surface, the interior wall surface at least partially defining an interior volume of the container, the method comprising:
transmitting an acoustic excitation signal from a first acoustic transducer mounted on the exterior wall surface, the acoustic excitation signal traveling through the solid wall towards the interior volume of the container;
receiving an acoustic response signal at a location on the exterior wall surface, the acoustic response signal having traveled through the solid wall and being responsive to the excitation signal;
processing response signal data representing at least a portion of the received acoustic response signal; and
distinguishing gas from liquid contents within the interior volume of the container based at least in part on said processing of the response signal data.

2. A method according to claim 1 wherein said receiving the acoustic response uses a second acoustic transducer.

3. A method according to claim 2 wherein the second acoustic transducer used for receiving the acoustic response is positioned on the exterior wall surface at a location horizontally adjacent to the first acoustic transducer.

4. A method according to claim 1 wherein said receiving the acoustic response uses said first acoustic transducer.

5. A method according to claim 1 wherein said distinguishing gas from liquid contents is for a location within the interior volume of the container adjacent to the first acoustic transducer.

6. A method according to claim 1 wherein said distinguishing is based at least in part on distinguishing an amount of acoustic energy that is reflected at the interior wall surface when in contact with liquid from amount of acoustic energy that is reflected at the interior wall surface when in contact with gas.

7. A method according to claim 1 wherein said distinguishing is based at least in part on evaluating acoustic energy that has passed through a portion of the internal volume of the container and has been reflected of one or more internal structures of the container.

8. A method according to claim 7 wherein said distinguishing includes detecting ingress of liquid into the container based at least in part on evaluating acoustic energy reflected from an interface between a floor of the container and a rising liquid surface within the container.

9. A method according to claim 1 wherein said distinguishing is based on at least a combination of: (a) evaluating acoustic energy decay within the solid wall; and (b) evaluating acoustic energy that has passed through a portion of the internal volume of the container and has been reflected of one or more internal structures of the container.

10. A method according to claim 1 wherein said distinguishing gas from liquid contents is distinguishing water from air.

11. A method according to claim 10 wherein the container forms part of a buoyancy tank configured to provide an upward buoyancy force thereby exerting an uplift tension on components of a subsea riser system for lifting a production fluid from a subsurface wellhead to a surface facility, and wherein said distinguishing water from air within the interior volume of the container includes detecting water ingress into the buoyancy tank.

12. A method according to claim 11 wherein the buoyancy tank comprises a plurality of vertically stacked ballast tanks of which said container is a single ballast tank, the method further comprising transmitting and receiving acoustic energy using acoustic transducers mounted on the each of the other plurality of ballast tanks.

13. A method according to claim 11 wherein an alert signal is automatically transmitted to a surface facility when a predetermined threshold value relating to water ingress into the buoyancy tank is met.

14. A method according to claim 1 further comprising transmitting and receiving acoustic energy using second and third acoustic transducers, said first, second and third acoustic transducers being mounted on the exterior wall surface so as to be separated from each other in a vertical direction, wherein said distinguishing gas from liquid contents includes evaluating a level of liquid within the container based at least in part on evaluating received acoustic energy at each of the vertically separated transducers.

15. A method according to claim 14 further comprising estimating a liquid ingression flow rate into the container based on the evaluation of received acoustic energy at each of the vertically separated transducers.

16. A method according to claim 14 wherein the first, second and third acoustic transducers are powered by one or more batteries, and power consumption is conserved by selectively reducing transmitting acoustic energy from at lease one vertically higher transducer when liquid has not been detected from at least one vertically lower transducer.

17. A system configured to non-invasively acoustically monitor contents of a container having a solid wall with an exterior wall surface and an interior wall surface, the interior wall surface at least partially defining an interior volume of the container, the system comprising:
a first acoustic transducer mounted on the exterior wall surface, the first acoustic transducer mounted and configured to transmit an acoustic excitation signal through the solid wall towards the interior volume of the container; and
a data processing system configured to process data representing a received acoustic response signal received at a location on the exterior wall surface, the acoustic response signal having traveled through the solid wall and being responsive to the excitation signal, the data processing system further configured to distinguish gas from liquid contents within the interior volume of the container based at least in part on said processing of the data from the received acoustic response signal.

18. A system according to claim 17 further comprising a second acoustic transducer mounted on the exterior wall surface at a location horizontally adjacent to the first acoustic transducer, the second acoustic transducer being configured to receive the received acoustic response signal.

19. A system according to claim 17 wherein the first acoustic transducer is configured to receive the received acoustic response signal.

20. A system according to claim 17 wherein the first acoustic transducer is formed of a piezoelectric ceramic material and forms part of a first acoustic transducer unit comprising two electrodes, a backing layer, and a permanent magnet configured to securely hold first acoustic transducer unit against the exterior wall of the container.

21. A system according to claim 20 further comprising second and third acoustic transducers, said first, second and third acoustic transducers being mounted on the exterior wall surface so as to be separated from each other in a vertical direction, and said first, second and third acoustic transducers forming at least part of an array of transducers.

22. A system according to claim 21 further comprising electronics configured to excite acoustic energy using transducers in said array, store data representing acoustic energy received using transducers in said array, and to transmit data one or more other components.

23. A system according to claim 20 wherein the container forms part of a buoyancy tank configured to provide an upward buoyancy force thereby exerting an uplift tension on components of a subsea riser system for lifting a production fluid from a subsurface wellhead to a surface facility, and wherein said distinguishing liquid from gas within the interior volume of the container includes detecting water ingress into the buoyancy tank.

24. A system according to claim 22 further comprising telemetry unit in communication with the electronics and configured to transmit an alarm to a surface facility when a predetermined threshold value relating to water ingress into the buoyancy tank is met.

25. A system according to claim 17 wherein said distinguishing is based on a combination of at least: (a) an evaluation of acoustic energy decay within the solid wall; and (b) an evaluation of acoustic energy that has passed through a portion of the internal volume of the container and has been reflected of one or more internal structures of the container.
